(19) United States
(12) Patent Application Publication
(10) Pub. No.: US 2002/0096505 A1
(43) Pub. Date: Jul. 25, 2002

(54) Constant speed weld process

(76) Inventor: Gregory Thomas Roth, Davison, MI (US)

Correspondence Address: VINCENT A. CICHOSZ, DELPHI TECHNOLOGIES, INC., Legal Staff, Mail Code: 480-414-420, P.O. Box 5052, Troy, MI, 48007-5052, US

(21) Appl. No.: 09/768,181

(22) Filed: Jan. 23, 2001

(51) Int. Cl. B23K 9/12

(52) U.S. Cl. 219/124.31; 219/125.11

(57) ABSTRACT

A constant linear weld speed process provides constant linear weld speed welding on circular and non-circular weld profiles. A constant linear weld speed device includes a weld fixture for holding a part such as a catalytic converter part, to be welded along a weld profile, the weld fixture having a shape that is substantially the same as said weld profile. A device, such as a constant rpm drive motor, is employed to rotate the part in the weld fixture about the central axis of the weld fixture. A movable weld torch, held to the weld fixture and disposed at an approximately 90° angle to the weld profile surface, is adapted to travel radially in and out so as to follow the weld fixture profile and provide a constant linear weld speed as the weld fixture and the part rotate about the central axis. In an alternate embodiment, the weld torch is adapted to move radially and pivotally.

### TECHNICAL FIELD

The present invention relates to exhaust apparatus and more particularly relates to a constant speed weld process for welding circular and non-circular weld profiles of catalytic converters.

### BACKGROUND OF THE INVENTION

It is known in the art relating to catalytic converters to provide a housing, such as of the clamshell type formed by two half shells joined along longitudinally extending flanges or of the stuffed type formed by welding end cones onto a shell, to form an enclosure for a catalytic element or substrate. In converters having frangible catalyst coated monolith elements, the housing may have a cylindrical interior of, for example, circular, oval or otherwise configured cross section, depending on the shape of the enclosed element. A supporting mat may be provided to allow for expansion while holding the catalyst element firmly in place. The clamshell housings are easy to assemble but have a longitudinal seam along both sides that must be welded or otherwise sealed.

It is preferred that circular and non-circular catalytic converters have constant linear weld speed to achieve consistent welds. With non-circular designs, variable angular rotation rates are employed to achieve the desired weld speed. Robotic weld equipment and automated weld cells with programmable cell controllers are known, which create variable rotation speed and programmed torch movements to accommodate non-circular weld profiles. Such approaches are expensive with respect to equipment and time. For example, variable weld schedules must be programmed for each profile. The large changeover time and complex maintenance required often results in costly downtime.

What is needed in the art is an improved process for preparing catalytic converters. What is further needed in the art is a low cost, simplified constant speed weld process for welding circular and non-circular weld profiles, particularly circular and non-circular catalytic converters.

### SUMMARY OF THE INVENTION

The present constant linear weld speed device for circular and non-circular weld profiles comprises a weld fixture for holding a part to be welded along a weld profile. The weld fixture has a shape that is substantially the same as the weld profile. A device is provided for rotating the weld fixture about its central axis. A movable weld torch is disposed at an approximately 90° angle to the weld profile surface. The movable weld torch is adapted to travel radially in and out so as to follow the weld fixture profile and provide a constant linear weld speed as the weld fixture and part rotate about the central axis of the weld fixture.

In a preferred embodiment, the movable weld torch is spring-loaded against the weld fixture. In yet another preferred embodiment, the device for rotating the weld fixture about its central axis is a constant speed drive motor connected to the weld fixture by a drive belt. The constant speed drive motor provides a constant belt speed, which in turn provides a constant surface speed (weld speed) at the weld torch location. Variable angular rotation rate of the weld fixture results as the radial distance from the center of the fixture to the tangent point of the belt varies as the non-circular fixture rotates.

The present constant linear weld speed process comprises disposing a part to be welded along a weld profile into a weld fixture having a shape that is substantially the same as the weld profile. The process comprises rotating the weld fixture about its central axis, and welding the part with a movable weld torch disposed at an approximately 90° angle to the weld profile surface. The movable weld torch is adapted to travel radially in and out so as to follow the weld fixture profile and provide a constant linear weld speed as the weld fixture and the part rotate about the central axis. In a preferred embodiment, the part to be welded comprises a catalytic converter part.

The present invention advantageously provides a simple means of achieving constant linear weld speeds on non-circular and circular weld profiles. The present invention provides the advantages of very low cost, lean equipment design for weld processes, such as GMAW (Gas Metal Arc Welding) and GTAW (Gas Tungsten Arc Welding) weld processes. The present constant weld speed device and process simplifies weld schedule programming and provides improved weld quality. The present constant weld speed device and process requires little, if any, variable weld schedule programming, thus reducing welder and control system costs. The present constant weld speed device and process is adaptable to any profile without programming. Advantageously, the present constant weld speed device and process simplifies changeover, requiring changing the weld fixture only. The simplified design and process further reduces maintenance costs over prior, high complexity weld processes.

These and other features and advantages of the invention will be more fully understood from the following description of certain specific embodiments of the invention taken together with the accompanying drawings.

### BRIEF DESCRIPTION OF THE DRAWINGS

Referring now to the drawings, which are meant to be exemplary, not limiting, and wherein like elements are numbered alike:

FIGS. 1A and 1B show a schematic depiction of a constant speed weld process and device in accordance with one embodiment of the present invention.

FIG. 2 shows a schematic depiction of an alternate embodiment of the constant speed weld process and device in accordance with the present invention.

FIG. 3 provides an enlarged view of a portion of the embodiment of FIG. 2.

FIG. 4 provides an enlarged view of a portion of the embodiment of FIG. 2.

### DESCRIPTION OF THE PREFERRED EMBODIMENT

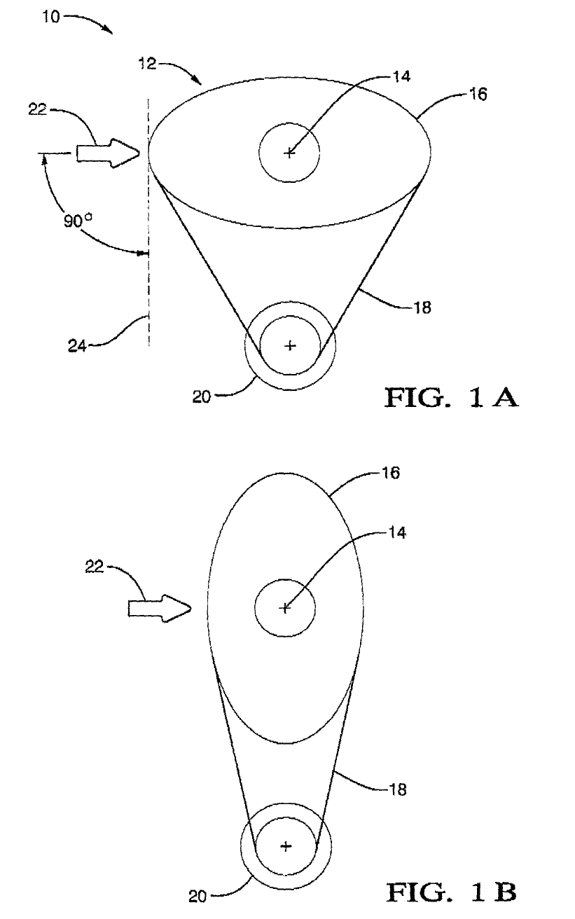

Referring to the FIGS. 1A and 1B, a constant speed weld process and device in accordance with one possible embodiment of the present invention is shown. The device and process provide a simple method for achieving constant linear weld speeds on circular and non-circular weld profiles. The present constant speed weld device 10 includes a weld fixture 12 having a central axis 14 and the same external profile 16 as the part being welded. The weld fixture 12 is connected by a belt 18 to a device 20 for rotating the weld fixture 12 about its central axis 14 at a constant speed, such as a constant speed drive motor 20. The device 20 for rotating the weld fixture 12 may comprise, but is not limited to, a constant speed drive motor, a rotary actuator, a stepper motor, or a gear motor. The weld fixture 12 rotates about its central axis 14 being belt driven along the external profile 16 of the weld fixture 12 by the constant speed drive motor 20.

A movable weld torch 22 is disposed at an approximately 90° angle to the weld profile linear surface 24. The weld torch 22 is spring-loaded or otherwise configured so as to travel radially, in and out, following the weld profile 16 as the weld fixture 12 and part rotate. Thus, constant linear weld speed is achieved via the constant speed belt 18 and the dynamic location of the movable weld torch 22 at the linear weld surface 24.

In the embodiment shown in FIGS. 1A and 1B, a non-circular catalytic converter (only weld profile is shown) is placed into the weld fixture 12 having the same shape as the converter weld profile (i.e., weld fixture profile 16 and converter weld profile are the same). The weld fixture 12 is rotated about is central axis 14 and is belt driven along the outer weld profile 16 by the constant speed belt 18 connected to the constant rpm drive motor 20. In this embodiment, the weld torch 22 is disposed at an approximately 90° angle to the motor 20 location (i.e., approximately 90° angle to the weld profile linear surface 24) and is spring-loaded to traverse radially following the weld fixture profile 16. While the angular velocity of the non-circular part (such as an oval stuffed converter) changes, the movable weld torch 22 adapts radially to the constant linear velocity at the weld surface 24. Thus, the torch 22 movement and weld speed are matched to the belt 18 speed, which is held constant by the constant rpm drive motor 20.

The present constant speed weld process may be used with various weld processes, such as, but not limited to, GMAW, GTAW, laser, or electron beam welding, and provides a very low cost automated weld process. Quick changeover is achieved by replacing the fixture 12 and re-attaching the belt 18 or other device for rotating the weld fixture about its central axis at a constant speed.

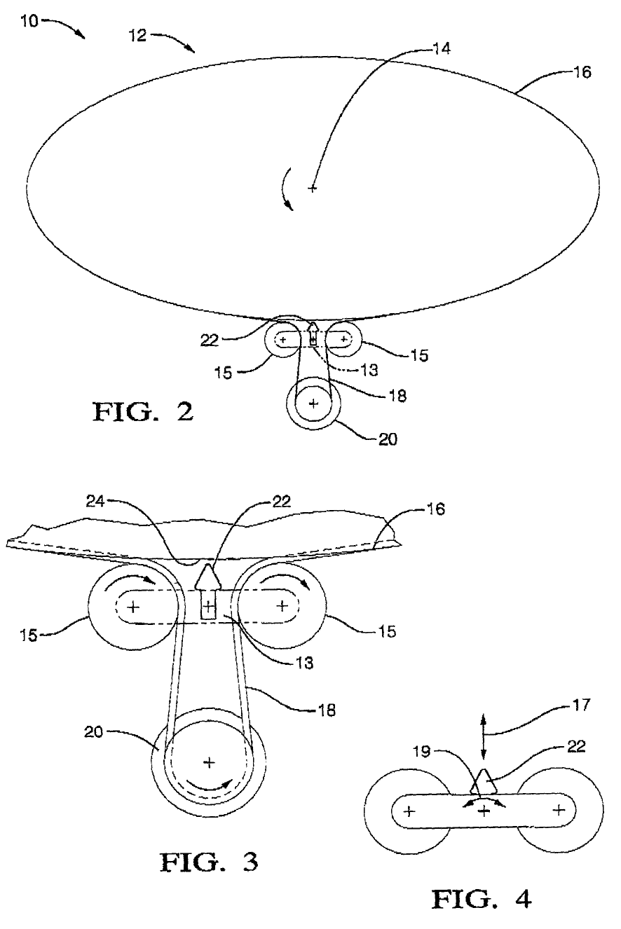

An alternate embodiment of the present constant speed weld device 10 and process is shown in FIG. 2. FIGS. 3 and 4 provide enlarged views of portions of the embodiment of FIG. 2. In this embodiment, a weld fixture 12 having the same shape as the weld profile 16 of the converter (or other part) to be welded is provided. A torch holder 13 holds weld torch 22. Torch holder 13 pivots and translates in and out to follow the fixture profile 16. The weld fixture 12 is belt driven by a drive belt 18 connected to a constant speed motor 20. The drive belt 18 disengages and re-engages the weld fixture 12 at the idler wheels 15 of the torch holder 13. The torch holder 13 is spring loaded against the fixture 12 and moves radially in and out (movement indicated by the vertical arrow 17) and rotates (rotating movement indicated by the curved arrow 19) to maintain both idler wheels 15 in contact with the fixture 12. The belt tangency point to the fixture 12 is thus kept at close proximity to the weld torch 22 for optimum constant speed operation and the torch 22 position is held at about 90° to the weld surface 24. The motor 20 is spring-loaded away from the torch holder 13 and arranged to keep the belt 18 tight.

The present constant speed weld device and process reduces equipment costs over currently available robotic and computer programmed weld processes. The present invention advantageously reduces the implementation time required for new shapes, as changeover generally involves only changing the weld fixture and reconnecting the constant linear weld speed device and does not require complex programming steps. The present constant speed weld process and device provide the further advantage of reduced maintenance costs.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. A constant linear weld speed device for circular and noncircular weld profiles comprising:
a weld fixture for holding a part to be welded along a weld profile surface, said weld fixture having a shape that is substantially the same as said weld profile;
a device for rotating said weld fixture about its central axis;
a movable weld torch held against said weld fixture and disposed at an approximately 90° angle to said weld profile surface, said movable weld torch adapted to travel radially in and out so as to follow said weld fixture profile and provide a constant linear weld speed as said weld fixture and said part rotate about said central axis.

2. The constant linear weld speed device of claim 1, wherein said part to be welded comprises a catalytic converter part.

3. The constant linear weld speed device of claim 1, wherein said movable weld torch is held against said weld fixture with a spring-loaded torch holder.

4. The constant linear weld speed device of claim 1, wherein said movable weld torch is held against said weld fixture with a spring-loaded torch holder, wherein said torch holder moves radially in and out and pivotally to provide a constant linear weld speed.

5. The constant linear weld speed device of claim 1, wherein said movable weld torch is a GMAW welder, a GTAW welder, a laser welder, or an electron beam welder.

6. The constant linear weld speed device of claim 1, wherein said device for rotating said weld fixture about its central axis at a constant speed is a constant speed drive motor, a rotary actuator, a stepper motor, or a gear motor.

7. The constant linear weld speed device of claim 1, wherein said device for rotating said weld fixture about its central axis is a constant speed drive motor connected to said weld fixture by a drive belt.

8. A constant linear weld speed process for circular and non-circular weld profiles comprising:
disposing a part to be welded along a weld profile into a weld fixture, said weld fixture having a shape that is substantially the same as said weld profile;
rotating said weld fixture about its central axis;
welding said part with a movable weld torch disposed at an approximately 90° angle to said weld profile surface, said movable weld torch adapted to travel radially in and out so as to follow said weld fixture profile and provide a constant linear weld speed as said weld fixture and said part rotate about said central axis.

9. The process of claim 8, wherein said part to be welded comprises a catalytic converter part.

10. The process of claim 8, wherein said movable weld torch is held against said weld fixture with a spring-loaded torch holder.

11. The process of claim 8, wherein said movable weld torch is held against said weld fixture with a spring-loaded torch holder, wherein said torch holder moves radially in and out and pivotally to provide a constant linear weld speed.

12. The process of claim 8, wherein said welding comprises GMAW welding, GTAW welding, laser welding, or electron beam welding.

13. The process of claim 8, wherein said rotating is with a constant speed drive motor, a rotary actuator, a stepper motor, or a gear motor.

14. The process of claim 8, wherein said rotating is with a constant speed drive motor connected to said weld fixture by a drive belt.
